(19) United States
(12) Patent Application Publication
(10) Pub. No.: US 2003/0113114 A1
(43) Pub. Date: Jun. 19, 2003

(54) Wavelength calibration system using out of band gas cell lines

(76) Inventor: Stephen Frank Blazo, Mulino, OR (US)

Correspondence Address: STEPHEN BLAZO, 14711 S BUCKNER CREEK ROAD, MULINO, OR, 97042, US

(21) Appl. No.: 10/017,626

(22) Filed: Dec. 18, 2001

(51) Int. Cl. H04J 14/02

(52) U.S. Cl. 398/25; 398/34

(57) ABSTRACT

This invention provides a means of calibrating a tunable filter, such as a Fabry-Perot tunable etalon, by means of a calibration signal outside the measurement range and inferring the calibration inside the measurement range by means of the equations of operation of the filter. The calibration scan is simultaneous with the measurement scan so the repeatability of the scan does not influence the calibration. In addition lower cost components, available in other wavelength regions, can be used for the calibration source.

### STATEMENT REGARDING FEDERALLY SPONSORED RESEARCH AND DEVELOPMENT

Not Applicable.

### BACKGROUND OF THE INVENTION

This invention relates to the use of gas cell absorption lines to calibrate the wavelength scale of an optical instrument where the gas cell lines fall within a wavelength range that the instrument operates but outside of the specified measurement range.

Gas molecular absorption has been used a calibration source for optical instrumentation especially in the fiber optic communication dense wavelength division multiplexing (DWDM) bands around 1550 nm. A typical use would be the calibration of optical spectrum analyzers or channel monitors. The National Institute of Standards and Technology (NIST) offers several Standard Reference Materials (SRMs) for this purpose. These SRMs are cells that are fitted with fiber optic collimators and contain a tube filled with a gas that absorbs radiation in well defined narrow absorption lines that are very accurately known. Light from the input fiber is collimated into a beam, traverses the tube undergoing selective absorption, and exits another collimator to be refocused on the output fiber. Two versions of the SRM are presently offered. One version, SRM2517A, uses a tube filled with carbon 12 acetylene gas and covers the frequency rang from 198 Terahertz (1515 nm) to 194.7 Terahertz (1540 nm). The other version, SRM 2519 uses carbon 13 hydrogen cyanide and covers the frequency range from 195.9 Terahertz (1530 nm) to 191.9 Terahertz (1565 nm). These frequency/wavelength references provide highly stable and accurate frequency standards.

A typical use for the gas cells would be to calibrate an optical spectrum analyzer or DWDM channel analyzer. This analyzer in the case of DWDM signals would typically have a wavelength range of 1520 to 1570 nm. The spectrum analyzer generally contains a tunable filter, often a tunable etalon. The tunable etalon operates as a comb filter and at any setting allows light to be transmitted at a comb of frequencies that are spaced by what is known as the free spectral range. For maximum resolution the free spectral range, which is a design variable, is typically taken to be just a little larger then the measurement range of interest. A typical measurement range might be 1520 nm to 1570 nm with a free spectral range of about 70 nm, slightly larger then the 50 nm measurement range. If the filter was set to transmit at 1550 nm it would also transmit at 1480 nm, 1410 nm, 1340 nm, 1270 nm, etc. As the etalon is scanned all orders of the etalon will scan inexactly the same way as described by the etalon model. For maximum accuracy the model will need to include effects such as dispersion of the medium used for the filter but these corrections are typically small and quite well known. The transmission of multiple orders does not lead to confusion if it is known that the signal only exists over a restricted wavelength range. Most tunable etalons are scanned be piezoelectric devices that exhibit various temperature humidity, and history effects. Thus tunable etalons need to have the wavelength scale of the scanning signal calibrated in order to be accurate. A typical configuration for calibration in the prior art is shown in FIG. 1. The input to the tunable filter 16 has an optical switch 10 to either present the unknown signal 12 or the calibration signal 14 to the tunable filter. The output of the tunable filter is converted to an electrical one for analysis by detector 18. The broadband source 20 can be a light emitting diode or an amplified spontaneous emission (ASE) source and emits a band of radiation covering the region of interest. This radiation illuminates the gas cell and undergoes selective absorption at the gas cell line wavelengths. The gas cell 22 is typically a tube filled with a gas and having fiber optic collimators on the input and output. Thus the calibration signal consists of broadband radiation with gas absorption lines. The filter is scanned with the optical switch coupling the calibration signal. The position of the gas lines is compared with the corresponding point on of the scanning signal of the tunable filter. This allows the precise wavelength scale of the scanning signal to be determined, at least at the gas cell lines themselves. To extend the range of calibration various curve fitting routines are typically used. These can be good for modest extrapolations but fail if the wavelength range is extended too far. The switch is then set to the unknown signal, a data scan taken, and the wavelength scale corrected with the previously determined corrections. This system has several drawbacks, such as:

1. The calibration and the scanning of the actual unknown signal must be done at two different times. Thus the quality of the calibration is a function of the repeatability of the scan.

2. In the DWDM band around 1550 nm broadband emitters such as an ELED are quite expensive

3. The gas lines from acetylene or hydrogen cyanide only cover about a 30 nm span which is insufficient to cover the entire wavelength of interest.

### BRIEF SUMMARY OF THE INVENTION

Accordingly the present invention utilizes the repeating nature of the tunable filter to characterize the wavelength/frequency scale in one wavelength range outside of the measurement range and infer the wavelength/frequency scale within the measurement range. This is done by using a gas cell that contains a gas with absorption bands outside the measurement range as well as a broadband emitter that emits in gas cell line range. Using commercially available wavelength multiplexers the calibration signal is multiplexed into the measurement signal at the input and demultiplexed at the output without affecting the measurement signal, allowing for calibration as well as measurement on the same scan. In a preferred embodiment the gas cell might contain hydrogen fluoride which has strong absorption lines from 1255 nm to 1335 nm, which covers a broader wavelength range then either acetylene or hydrogen cyanide. Several objects and advantages of the present invention are:

1. Provide a wavelength/frequency calibration of a tunable filter by calibration outside of the measurement range of interest

2. Have the calibration be able to be done simultaneously with the measurement scan.

3. Utilize lower cost components such as broadband emitters that are available in other wavelength ranges

4. Utilize gas absorption species that have absorption lines over a larger wavelength range then that offered by species available within the measurement range itself

### DESCRIPTION OF DRAWINGS

FIG. 1 is a block diagram of an example calibration system for a tunable filter using prior art

FIG. 2 is a graph of the transmission characteristics of a tunable etalon

FIG. 3 is a block diagram of a preferred embodiment of the present invention

FIG. 4 is an alternate embodiment of the present invention employing the gas cell after the tunable filter

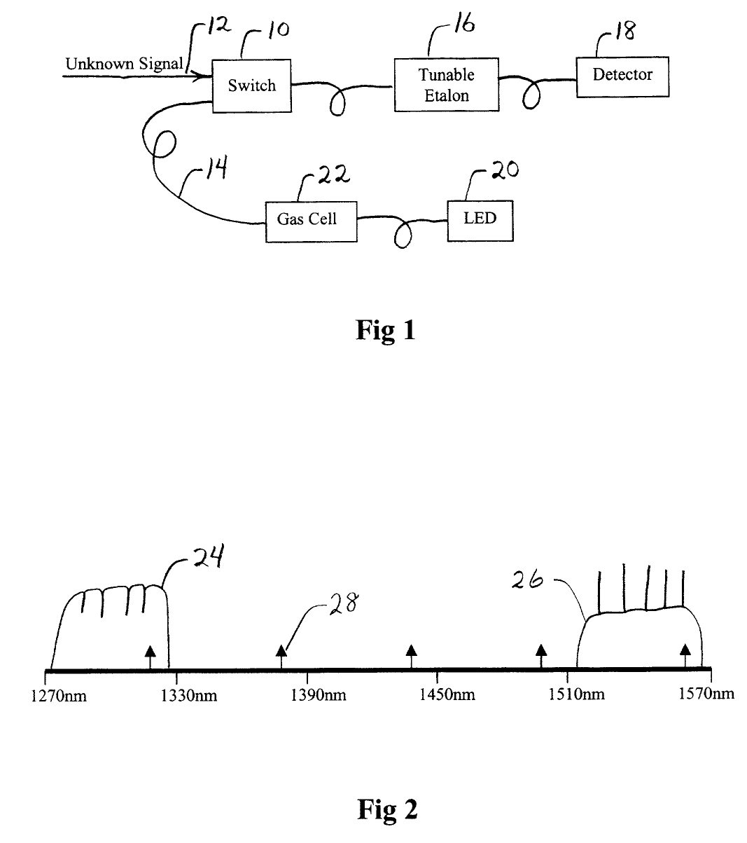

### DETAILED DESCRIPTION OF THE INVENTION

A tunable etalon is made from a cavity with partially reflecting mirrors at each end. This cavity will transmit light as described by the equations of the Fabry-Perot etalon. The etalon can be made to be tunable if the cavity can be adjusted, for example, by a piezoelectric device. The tunable etalon will transmitt signal at a comb of wavelengths each separated by the free spectral range. This is illustrated in FIG. 2. The free spectral range in this case is approximately 60 nm. The scan would typically be set to about 50 nm. As the scan is swept by applying voltage to the piezo the filter will transmit at each corresponding point on the various orders of the filter. For example if the filter were set to transmit at 1550 nm it would also transmit at 1490 nm, 1430 nm, 1370 nm shown at 28, and 1310 nm. The exact wavelength of transmission of the multiple orders is described by the equations of the Fabry-Perot etalon and will include effects such as the dispersion of the medium or mirror coatings. Shown in the drawing are the DWDM signal 26 in the 1550 nm region as well as a signal in the 1310 nm region 24 whose significance will become apparent as the means of calibration.

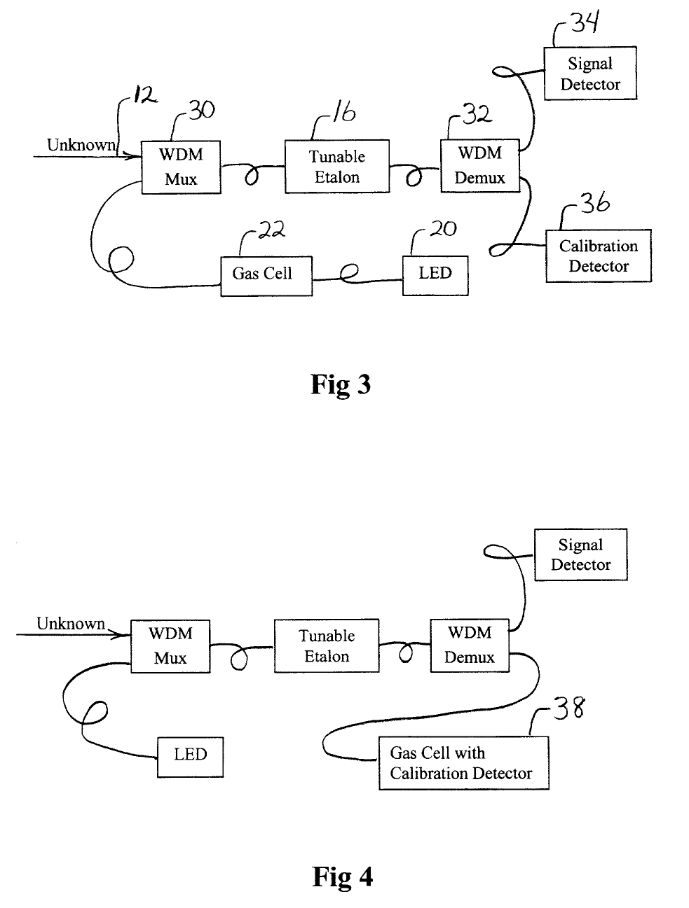

A preferred embodiment of the present invention is shown in FIG. 3. The unknown input signal 12 is multiplexed with the signal 14 from the calibration source by multiplexer 30. The unknown signal has wavelengths within the DWDM band from 1528 nm to 1562 nm for the case of a C-band system but does not have signals at other wavelengths. The calibration source has wavelengths within a certain band not containing the signal wavelengths and nowhere else. The signal combining is typically done by using a WDM combiner such as the JDS WD1315 series. The calibration source is comprised of a broadband emitter 20 and a gas cell 22. If the gas cell is hydrogen fluoride which has strong absorption line from 1255 nm to 1335 nm, inexpensive 1300 nm LEDs may be used. These devices are available from several vendors such as MRV Inc. The multiplexed signal is applied to the tunable filter 16. The output of the tunable filter is applied to another WDM 32, this time acting as a demultiplexer which separates the wavelength bands from one another. The calibration and unknown signals are detected by separate detectors 34 and 36.

The operation of the system can be understood by study of FIG. 2 which shows the transmission of the tunable etalon in the wavelength bands as well as the presence of the unknown signal 24 and the calibration signal 26. The transmission of an etalon is described by the equations of a Fabry-Perot etalon. The free spectral range is the space between repeating orders of the etalon, in this case approximately every 60 nm. At any position of the scan, schematically shown by arrows on the wavelength axis 28, both the unknown signal at a particular wavelength and the calibration signal at the corresponding wavelength in another order of the etalon will be transmitted by the etalon. Signals in these wavelengths will each be split off and delivered to their corresponding detector. The calibration signal 24 will consist of the LED spectrum with the gas lines showing as dips in the intensity. These dips correspond to molecular energy levels and are extremely accurate and stable. The signal spectrum 26 typically consists of DWDM channels riding on top of an amplified spontaneous emission (ASE) noise floor. These signals are detected in separate detectors which convert them to electrical signals for analysis. The gas line positions, detected simultaneously with the unknown signal, are used to calibrate the scan of the unknown signal. The gas cell line positions may extend into more then one order of the etalon if, for example, the gas cell lines extend over 50 nm spectral range and the free spectral range is 35 nm. This can lead to some confusion but with care this actually presents no fundamental problem. The gas cell lines and orders can be unequivocally determined by pattern recognition on the gas cell lines and intensities, which being related to fundamental molecular energy levels are stable and reproducible. It is also possible to include some single line Fiber Bragg Gratings in series with the gas cell to mark a starting point for the pattern recognition.

FIG. 4 shows an alternate embodiment of the system wherein the gas cell is placed after the demultiplexer. This is useful since the gas cell need not be fabricated with fiber optic input and output but rather have the detector included in the gas cell package 38. This can lower the overall cost significantly.

### CONCLUSIONS, RAMIFICATIONS, AND SCOPE

The techniques and apparatus described by this invention can be used to calibrate a tunable filter exhibiting a repeating transmission form, such as a Fabry-Perot tunable filter. The filter is calibrated in one order of the filter and the calibration in the other, signal measurement, order inferred by etalon equations. This allows the calibration and measurement process to proceed with a simultaneous scan, not dependent on the scan repeatability. In addition lower cost components available at other wavelength bands can be used as well as gas species having more advantageous absorption spectra.

I claim

1. An apparatus for calibrating a tunable filter simultaneously with the measurement wherein the tunable filter exhibits a repeating wavelength transmission at various orders by means of a calibration signal generated by broadband emitter and a gas cell in series where the gas cell and broadband emitter absorb and emit at wavelengths outside the measurement range of interest and at another order of the filter where the unknown signal and calibration signal are combined at the input to the filter by means of a wavelength multiplexer and separated at the output of the filter by a wavelength demultiplexer.

2. The apparatus in 1, where the gas cell instead of being placed at the input of the wavelength multiplexer is instead placed at the output of the demultiplexer.
